(19) United States
(12) Patent Application Publication
(10) Pub. No.: US 2026/0314631 A1
(43) Pub. Date: Oct. 15, 2026

(54) PROCESS FOR EXTRACTING MUNG BEAN PROTEIN

(71) Applicant: Sattvaponics Solutions Pvt Ltd, Mumbai (IN)

(72) Inventors: Kevin PAREKH, Surat (IN); Ashish KORDE, Nagpur (IN); Nilambari C. KASHIKAR, Satara (IN); Anuradha CHITNIS, Mumbai (IN); Mrunal SALI, Ahmednagar (IN)

(73) Assignee: Sattvaponics Solutions Pvt Ltd, Mumbai, MH (IN)

(21) Appl. No.: 19/106,610

(22) PCT Filed: Aug. 25, 2023
(86) PCT No.: PCT/IN2023/050805

§ 371 Date: Feb. 25, 2025

(30) Foreign Application Priority Data
Aug. 26, 2022 (IN) 202221048784

(51) Int. Cl. A23J 1/14; A23J 3/14; A23L 15/00

(52) U.S. Cl. CPC A23J 1/14; A23J 3/14; A23L 15/35

(57) ABSTRACT

The present invention relates to a process for mung bean protein extraction. More particularly, the present invention provides a process for mung bean protein extraction with high protein purity by adding antifoaming agent at multiple steps for high protein yield and can balance high functionality and desired organoleptic properties of the mung bean protein extract. The mung bean protein extract is in the form of isolate or concentrate which has applications in food and beverage industries.

### FIELD OF THE INVENTION

The present invention relates to a protein concentrate isolated from a plant source. More particularly, the present invention provides a mung bean protein concentrate and a process for mung bean protein concentrate extraction with high functionality, high protein purity, and high protein yield and desired organoleptic properties.

### BACKGROUND OF THE INVENTION

Proteins of plant origin, particularly those from oilseeds, legumes, and cereals, are economical and renewable sources of dietary proteins. Mung beans are praised as an important food with high nutritional value. The mung beans have high protein content of about 20 percent, complete amino acid types, high protein efficiency ratio, belong to the first group of various beans, and have development value.

Plant proteins are currently widely utilized in the food industry, mainly from legumes, due to their excellent functional characteristics, such as foam formation, emulsification, gelation, solubility, film-forming and water holding capacity. Conventional methods and processes used for extracting legume protein isolates and concentrates include alkaline extraction and acid precipitation or ultrafiltration (wet process) and air classification (dry process). The quality of the legume protein compositions produced by these methods is directly dependent on the operating conditions used to prepare them. Moreover, the characteristics of legume proteins are closely related to their utilization and functions, which makes it possible to be used successfully as ingredients in food systems. It may therefore be necessary to modify the protein compositions so as to confer desired properties in the context of food applications.

Most of the conventional processes are aimed at increasing the mung bean protein recovery and yield and yet are not able to achieve high functionality and desired organoleptic profile and as a result the mung bean protein concentrates/isolates available in the market fair low on functionality and have poor organoleptic properties.

Further, the existing processes have the inherent drawback of inferior functional parameters. The treatment of alkali and acids, carrying out processes at higher temperatures and other process parameters negatively influence functional properties like water holding capacity, oil holding capacity, gelation, foaming, emulsification, etc. making it a sub-par ingredient and animal protein replacement. Also, many methods employ use of expensive processing aids and other equipment, methods and process aids that make the cost of production expensive.

U.S. Pat. No. 8,563,071B2 is directed to the production of protein solutions from soy and to novel soy protein products. The protein extraction is affected with calcium salt solution. However, the quantity of salt hampers the production of the protein products that affect the functionality of proteins in the protein product. US2021259281A1 discloses a method for preparing pulse protein isolates by filtration and ultrafiltration using the step of milling the pulse protein isolates and mixing them with an aqueous solution to form a slurry in a ratio of 1:10 and applying the protein-rich fraction to an ultrafiltration process. The process also discloses the use of a de-foaming agent which is added to the slurry to reduce foaming during the mixing process; accompanied by isoelectric precipitation and disc stack centrifuge to obtain the product. However, US2021259281A1 remains silent regarding the explicit use of the de-foaming agent in at least one of the intermediate steps. Further, the product of US2021259281A1 was immediately placed in a freezer at −18° C., thawed on the following day, and then stored under refrigeration at 4° C.; however, freezing step before spray drying has not been explicitly mentioned.

AU2020292412A1 discloses a food product comprising a mung protein and a method for isolating a plant protein isolates or plant protein concentrates comprising mung bean protein; wherein the first step is dehulling the raw source material, subjected to milling process to obtain well define particle sizes. Further, the process involves the milling of pulse protein isolates and mixing with an aqueous solution to form slurry in a ratio of 1:10. Further, protein extraction process is done at pH 9 with 50% sodium hydroxide solution (NaOH). The process further discloses the use of a de-foaming agent which is added to the slurry to reduce foaming during the mixing process; accompanied by isoelectric precipitation using HCl. Disc stack centrifuge is also being used to obtain the product. Use of spray drying step for removing excess of water has also been mentioned in said reference. However, the prior art discloses that a de-foaming agent is not utilized during extraction. It further remains silent regarding the step of physico-thermal conditioning carried out at a temperature in the range of −22° C. to −16° C.

CN101238846A discloses isolating edible protein in the mung bean and pea with good appearance, quality, solubility, and emulsifying properties. However, the edible protein has maximum solubility of 61%.

The existing mung bean protein extraction process options have many functional and purity concerns and hampers the desired organoleptic properties of the extracted proteins.

Thus, there remains a need for processes of isolating mung bean proteins with physical characteristics such enhanced solubility, foam stability and dispersibility and organoleptic properties desirable to produce food products, including alternatives to conventional products containing animal proteins.

Thus, the inventors of the present invention has successfully addressed the drawbacks of the existing technology and formulated a protein extraction process with high purity and yield while retaining the functionality of the extracted proteins.

### Object of the Invention

An object of the present invention is to provide a process to obtain a mung bean protein extract with high functionality, protein yield and high protein purity.

Another object of the present invention is to provide a process to obtain a mung bean protein extract with desired organoleptic properties.

Yet another object of the present invention is to provide a mung bean protein isolate with high functionality, protein yield, high protein purity and desired organoleptic properties using said process.

### SUMMARY OF THE INVENTION

The present invention relates to a mung bean protein concentrate extract. The extracted protein has high functionality and desired organoleptic profile. Hence, the inventors of the present invention has successfully addressed the drawbacks of the existing technology and formulated a protein extract process with high purity and yield while retaining the functionality of the extracted proteins.

The present invention also relates to a process for extracting mung bean protein powder with high functionality and desired organoleptic profile comprising: reducing the particle size of the mung bean to obtain a flour of particle size less than 1000 μm; mixing said flour with water in a ratio of 1:5 to 1:10 to obtain a first slurry; solubilizing protein under stirring conditions over a time period of 30 mins to 1 hour by adjusting the pH of said first slurry in a range selected from 8 to 14 to obtain a solubilized protein; separating said solubilized protein from starch by using at least one of centrifugation, membrane filtration, hydro cyclone and combinations thereof to obtain a high purity protein in a supernatant; subjecting said supernatant through a separation step to obtain a high purity protein slurry, wherein said separation step is at least one of centrifugation, micro ultra filtration or nano filtration; subjecting said high purity protein slurry to physico-thermal conditioning followed by adjusting the pH to 7 to obtain a conditioned mung bean protein in aqueous medium; dispersing said conditioned mung bean protein in aqueous medium to obtain dispersed mung bean protein followed by spray drying at pre-determined temperature for pre-determined time to obtain said mung bean protein powder; wherein an antifoaming agent in predetermined quantity is added in at least one of the above-mentioned steps to obtain said mung bean protein powder.

In another aspect of the present invention, a mung bean protein concentrate is disclosed with high functionality and desired organoleptic profile. In one embodiment, the enhanced functional features of mung bean protein relate to at least one selected from solubility, dispersibility, foaming capacity and foaming stability.

In yet another preferred embodiment, the present invention provides a process for obtaining a mung bean protein concentrate extract with high functionality having applications in food and beverage applications.

In various embodiments, any of the features or components of embodiments discussed above or herein may be combined, and such combinations are encompassed within the scope of the present disclosure. Any specific value discussed above or herein may be combined with another related value discussed above or herein to recite a range with the values representing the upper and lower ends of the range, and such ranges and all intermediate values are encompassed within the scope of the present invention. Other embodiments will become apparent from a review of the ensuing detailed description.

### BRIEF DESCRIPTION OF THE DRAWINGS

Having thus described example embodiments of the disclosure in general terms, reference will now be made to the accompanying drawings, which are not necessarily drawn to scale, and wherein:

FIG. 1 illustrates an SDS page analysis of phytochemicals, in accordance with one embodiment of the present disclosure; wherein 1 represents Batch A—4 μl, 2 represents Batch A—8 μl, 3 represents Batch A—12 μl, 4 represents Batch B—10 μl, 5 represents Batch B—5 μl, 6 represents Batch B—15 μl, and M represents marker;

### DESCRIPTION OF THE INVENTION

In the description that follows, several terms are used, the following definitions are provided to facilitate understanding of various aspects of the disclosure. In the specification, the word “comprising” is used as an open-ended term, substantially equivalent to phrase “including, but not limited to,” and the word comprises has a corresponding meaning.

The terms and words used in the following description are not limited to the bibliographical meanings but are merely used to enable a clear and consistent understanding of the disclosure. Accordingly, it should be apparent to those skilled in the art that the following description of exemplary embodiments of the present disclosure are provided for illustration purpose only and not for the purpose of limiting the disclosure as defined by the appended claims and their equivalents.

In describing the embodiment of the invention, specific terminology is chosen for the sake of clarity. However, it is not intended that the invention be limited to the specific terms so selected, and it is to be understood that such specific terms include all technical equivalents that operate in a similar manner to accomplish a similar purpose. As used herein, reference to an element by the indefinite article “a” or “an” does not exclude the possibility that more than one of the elements is present, unless the context clearly requires that there is one and only one of the elements.

The present invention now will be described hereinafter with reference to the detailed description, in which some, but not all embodiments of the inventions are indicated. Indeed, the invention may be embodied in many different forms and should not be construed as limited to the embodiments set forth herein; rather, these embodiments are provided so that this disclosure will satisfy applicable legal requirements. Like numbers refer to like elements throughout. The present invention is described fully herein with non-limiting embodiments and exemplary experimentation.

In first aspect, the present invention relates to a process for extracting mung bean protein concentrate powder with high functionality and desired organoleptic profile comprising: soaking mung bean in a wetting solvent; size reducing said wet mung bean using wet milling or pulverizing a dry mung bean into flour; optionally, dry fractionating said flour to obtain protein rich fraction and a coarse starch rich fraction; mixing said protein rich fraction or flour with solvent in pre-determined ratio to obtain a first slurry; adjusting said first slurry to pre-determined pH using an alkali; adding an anti-foaming agent to said slurry and stirring for pre-determined time period to obtain an extract; subjecting said extract to separation of solids by at least one method selected from centrifugation, membrane filtration and hydrocyclone to obtain a supernatant, precipitating mung bean protein by adjusting pH of said supernatant using an acid; separating said mung bean protein precipitate using at least one method selected from centrifugation and membrane filtration to obtain a mung bean protein slurry; optionally, precipitating protein by adjusting pH of said supernatant using an acid; adjusting the pH of said protein slurry using an alkali; subjecting said pH adjusted mung bean protein slurry to physico-thermal conditioning; dispersing said conditioned protein in aqueous medium to obtain dispersed mung bean protein; spray drying said dispersed solid mung bean protein at pre-determined temperature for pre-determined time to obtain a fine mung bean protein powder.

The mung bean botanical name Vigna radiata, alternatively known as the green gram and maash, is a plant species in the legume family. The mung bean is native to the Indian subcontinent and is widely cultivated in Asia for use in a variety of sweet and savory dishes, particularly in India, China, Korea, and Thailand. It is also grown in relatively dry tropical and subtropical areas, including the Caribbean and parts of Africa. The mung beans required for the process of the present invention is commercially sourced as valued added product from India.

In one embodiment, mung beans are soaked in a solvent at least one including but not limited to water or any other non-reacting solvent. Typically, the mung beans are soaked in water for suitable time such that mung beans are wet. Further, the wet mung beans are subjected to size reduction using at least one including but not limited to wet milling to obtain a first slurry.

In an alternative embodiment, dry mung bean protein source is pulverized into flour. In yet another preferred embodiment, during the pulverizing step, the average particle size of said protein extract is reduced to achieve high yield without having any detrimental impact on the purity of the protein isolate.

In an alternative embodiment, dry mung bean protein source is milled into flour. In yet another preferred embodiment, during the milling step of said the average particle size of said protein extract is reduced to achieve high yield without having any detrimental impact on the purity of the protein isolate.

In an exemplary embodiment, the mung bean protein source is milled or pulverized to obtain a flour of size less than 1000 micron using a plate mill.

In another embodiment, the flour is fractionated to obtain a protein rich fraction and a coarse starch rich fraction. In an exemplary embodiment, the flour is dry fractionated using air classifier.

In an alternative embodiment, the process of pulverization and dry fractionation can be done on coarse starch fraction to obtain a protein fraction of high purity.

In one embodiment, the flour is mixed with solvent in pre-determined ratio to obtain a first slurry. In one embodiment, the solvent is water. The mixing of flour with solvent in predetermined ratio is referred as a suitable ratio where slurry of predetermined characteristics is obtained. In an exemplary embodiment the flour is mixed with water at 1:5 to 1:10 to obtain a first slurry.

In one embodiment, the pH of first slurry is adjusted using alkali to solubilize protein under stirring conditions over a time period of 30 mins to 1 hour. The pH of said first slurry is adjusted in the range of 8 to 14 using an alkali. In an exemplary embodiment the pH of said first slurry is adjusted to 9 using at least one selected from NaOH and suitable food grade alkali.

In one embodiment, the anti-foaming agent is added to said first slurry followed by stirring for a pre-determined period to obtain a mung bean protein extract. In yet another embodiment of the present invention, said anti-foaming agent includes but is not limited to cetostearyl alcohol, stearates, polydimethylsiloxane, silicone, polyethylene glycol-based processing aids. In an exemplary embodiment, the anti-foaming agent is polypropylene glycol. In another embodiment, the first slurry is stirred for 1 hour at room temperature after adding anti-foaming agent. In a preferred embodiment, the antifoaming agent is added to the first slurry after adjusting the pH of the first slurry, wherein, said antifoaming agent is selected in the range from 0.1 to 10 ppm with respect to the total weight of the mung bean extraction slurry.

The anti-foaming agent is added to the slurry to control the foaming during the mixing process thus leading to higher yield of highly functional proteins. The use of anti-foaming agent and temperature conditioning owing to the freezing step enable high recovery of highly functional proteins. Further, the addition of the anti-foaming agent aid is to achieve the optimal particle size distribution by retaining lower molecular weight and smaller particle size proteins and minimizing their loss during the process.

In one embodiment, subjecting said mung bean extract to separation of solids by at least one selected from centrifugation, decanter, membrane filtration, hydrocyclone or any other suitable solid separation method to obtain a supernatant. In an exemplary embodiment, the solids are separated using centrifugation is carried out using basket centrifuge followed by a disc bowl centrifuge. In an alternative embodiment, the solid separation is carried out using membrane filtration. This solid separation step ensures that starch is removed from said extract.

In another embodiment, said protein precipitate is separated using at least one separation method selected from centrifugation, membrane filtration, ultrafiltration, or any suitable protein purification method centrifugation to obtain a protein slurry. In an exemplary embodiment, the separation of protein extract is carried out using basket centrifuge followed by disc centrifuge.

In one embodiment, said separation of protein extract is carried out by subjecting centrifuged supernatant to ultrafiltration or nanofiltration using membrane filtration to a high purity protein slurry. In one embodiment, the membrane filtration of said is performed using at least one filter selected from micro, ultra and nano filters. The filter can be at least one selected from single, multiple or combinations thereof. The membrane filtration of protein extract enables a continuous process thereby reducing processing time which may also reduce chances of microbial contamination.

In an alternative embodiment, the precipitation of protein is carried out using iso-electric precipitation by adjusting pH of said supernatant using an acid. In yet another embodiment, the precipitation technique is an isoelectric precipitation. The pH of the supernatant is adjusted in the range of 3 to 6 using an acid at least one selected from HCl, HNO₃, Phosphoric acid, citric acid, acetic acid. In an exemplary embodiment, pH is adjusted to 4.5 using HCl for a time period of one hour. In preferred embodiment, said antifoaming agent is added to the step of adjusting pH of said supernatant using an acid, wherein, said antifoaming agent selected in the range from 0.1 to 10 ppm with respect to the total weight of the mung bean protein slurry.

In one embodiment, the high purity protein slurry is subjected to physico-thermal conditioning followed by adjusting the pH to 7 using food grade alkali to obtain a conditioned mung bean protein in aqueous medium; the pH of said protein slurry is adjusted using an alkali at least one selected from NaOH and suitable food grade alkali. In an exemplary embodiment, the NaOH is used to adjust the pH of the protein slurry to 7. In an exemplary embodiment, the conditioned mung bean protein is subjected to at least one selected from freeze drying, −22° C. to −16° C. to ensure better functionality. In preferred embodiment, said antifoaming agent is added to the step of physico-thermal conditioning of the pH adjusted protein slurry, wherein, said antifoaming agent selected in the range from 0.1-10 ppm with respect to the total weight of the protein slurry. Generally, physico-thermal conditioning of proteins refers to the process of subjecting proteins to specific physical and thermal treatments to modify their structure, functionality, or other properties. This can involve various techniques aimed at altering the protein's conformation, solubility, stability, and interactions. The physico-thermal conditioning is done to improve the protein's performance in various applications, such as food processing, pharmaceuticals, and industrial processes. The non limiting examples of physico-thermal conditioning includes heat treatment, denaturation and renaturation, aggregation and gelation, Maillard reaction, protein unfolding and refolding, enzymatic modifications, freeze-thaw cycling and extrusion and high-pressure processing, preferably heat treatment.

In another embodiment, the pH of said protein slurry is adjusted using an alkali at least one selected from NaOH and suitable food grade alkali. In an exemplary embodiment, the NaOH is used to adjust the pH of the protein slurry to 7. The pH adjusted protein slurry is subjected to physico-thermal conditioning to obtain a conditioned mung bean protein in aqueous medium. In an exemplary embodiment, the conditioned mung bean protein is subjected to at least one selected from freeze drying, −22° C. to −16° C. to ensure better functionality. In preferred embodiment, said antifoaming agent is added to the step of physico-thermal conditioning of the pH adjusted protein slurry, wherein, said antifoaming agent selected in the range from 0.1-10 ppm with respect to the total weight of the protein slurry.

In one embodiment, the conditioned protein is dispersed in aqueous medium to obtain dispersed protein. In an exemplary embodiment, the protein is dispersed in water using stirrer or any other suitable dispersing equipment.

In one embodiment, spray drying said dispersed protein at pre-determined temperature for pre-determined time using suitable spray drying equipment to obtain a fine protein powder. In another embodiment, said dispersed protein is mixed for proper dispersion of the solids to enhance the functionality and purity of the protein. In one embodiment, the spray drying equipment atomizer operating at desired specifications to ensure minimal protein denaturation and maintaining the high functionality.

In an embodiment, said mung bean protein powder is at least one selected from mung bean protein isolate and mung bean protein concentrate.

In one embodiment, anti-foaming agent is added at multiple above mentioned process steps. The anti-foaming agent is added to the slurry to control the foaming during the mixing process thus leading to higher yield of highly functional proteins. The use of anti-foaming agent and temperature conditioning owing to the freezing step enable high recovery of highly functional proteins.

In an exemplary embodiment of the present invention, the process for extracting mung bean protein powder comprising the steps of:
i. milling a mung bean to obtain a flour of particle size less than 1000 μm;
ii. mixing said flour with water in a ratio of 1:5 to 1:10 to obtain a first slurry;
iii. solubilizing protein under stirring conditions over a time period of 30 mins to 1 hour by adjusting the pH of said first slurry in a range selected from 8 to 14 to obtain a solubilized protein;
iv. separating said solubilized protein from starch by using at least one of centrifugation, membrane filtration, hydro cyclone and combinations thereof to obtain a high purity protein in a supernatant;
v. subjecting said supernatant through a separation step to obtain a high purity protein slurry, wherein said separation step is at least one of centrifugation, micro ultra filtration or nano filtration;
vi. subjecting said high purity protein slurry to physico-thermal conditioning followed by adjusting the pH to 7 to obtain a conditioned mung bean protein in aqueous medium;
vii. dispersing said conditioned mung bean protein in aqueous medium to obtain dispersed mung bean protein followed by spray drying at pre-determined temperature for pre-determined time to obtain said mung bean protein powder;
   wherein an antifoaming agent in predetermined quantity is added in at least one of the above-mentioned steps to obtain said mung bean protein powder.

In another embodiment of the present invention, the flour is dry-fractionated using air classification to obtain a fine protein rich fraction and a coarse starch rich fraction. The coarse starch rich fraction further undergoes multiple steps of milling and air classification to further obtain fine protein rich fraction. Further, the high purity protein in the supernatant is subjected to isoelectric precipitation followed by adjusting the pH to attain a range of 2 to 5.0 using 5N food grade HCl.

In another aspect of the present invention, a mung bean protein concentrate is disclosed with high functionality and desired organoleptic profile. In one embodiment, the enhanced functional features of mung bean protein relate to at least one selected from solubility, dispersibility, foaming capacity and foaming stability.

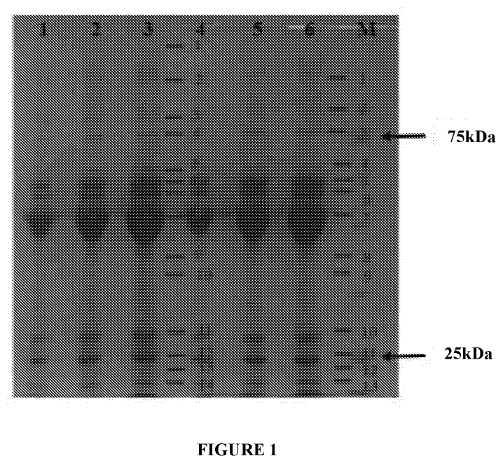

FIG. 1 depicts an SDS page analysis of phytochemicals. In FIG. 1, 1 represents Batch A—4 μl, 2 represents Batch A—8 μl, 3 represents Batch A—12 μl, 4 represents Batch B—10 μl, 5 represents Batch B—5 μl, 6 represents Batch B—15 μl, and M represents marker.

The above enhanced functional properties of mung bean protein which are achieved during extraction process contribute to desired organoleptic profile. The desired or organoleptic profile results into good taste and texture of the obtained mung bean protein concentrate.

In yet another preferred embodiment of the present invention provides a mung bean protein extract obtained using said process which may comprise one or more desirable food qualities, including but not limited to, high protein content, high protein purity, reduced retention of small molecular weight non-protein species (including mono and disaccharides), reduced retention of oils and lipids, superior structure building properties such as high gel strength and gel elasticity, superior sensory properties, and selective enrichment of highly functional 8s globulin/beta conglycinin proteins.

In yet another preferred embodiment, the present invention provides a mung bean protein extract using said process which may have one or more functional properties alone or when incorporated into a food composition. Such functional properties may include, but are not limited to, one or more of emulsification, water binding capacity, foaming, gelation, crumb density, structure forming, texture building, cohesion, adhesion, elasticity, springiness, solubility, viscosity, fat absorption, flavor binding, coagulation, leavening, aeration, creaminess, film forming property, freeze stability, thaw stability, or color.

In some embodiments, at least one functional property of the protein isolate differs from the corresponding functional property of the source of the plant protein. In some embodiments, at least one functional property of the protein isolate (alone or when incorporated into a food composition) is similar or equivalent to the corresponding functional property of a reference food product, such as, for example, an egg (liquid, scrambled, boiled or in patty form), a cake (e.g., pound cake, yellow cake, or angel food cake), a cream cheese, a pasta, an emulsion, a confection, an ice cream, a custard, milk, a deli meat, chicken (e.g., chicken nuggets), or a coating. In some embodiments, the protein isolate, either alone or when incorporated into a composition, is capable of forming a gel under heat or at room temperature.

In yet another preferred embodiment, said protein of the present invention may have modulated organoleptic properties of one or more of the following characteristics: astringent, beany, bitter, burnt, buttery, nutty, sweet, sour, fruity, floral, woody, earthy, beany, spicy, metallic, sweet, musty, grassy, green, oily, vinegary, neutral, and bland flavor or aromas. In some embodiments, the pulse protein isolates exhibit modulated organoleptic properties such as a reduction or absence in one or more of the following: astringent, beany, bitter, burnt, buttery, nutty, sweet, sour, fruity, floral, woody, earthy, beany, spicy, metallic, sweet, musty, grassy, green, oily, vinegary neutral and bland flavor, or aromas.

In yet another preferred embodiment, the present invention provides a process for obtaining a protein extract with high functionality having applications in food and beverage applications including but not limited to plant based egg replacement products, plant based omelette, plant based scrambled eggs, egg free cake/cake mix, egg free mayonnaise, egg free patty, egg free quiches, egg free ice-creams, egg free frozen desserts, egg free baked good, egg free confectionary, egg free sweets, egg free chocolates, functional egg replacement for pasta, pasta dough, noodles, breaded foods, dairy free milk, dairy free butter, dairy free cheese, dairy free cream, airy free cream cheese, dairy free yogurt, meat alternatives, vegan chicken nugget applications, meat free sausages, plant based sea food, vegan crab meat analogues, vegan deli meat analogues, sauces, dips, soups, custards and puddings, frozen prepared foods, broth, egg free egg nogs, functional food, beverages, protein supplements, protein shakes, nutraceutical applications, etc.

In one embodiment, the protein powder prepared using the above said process retains functional protein with desired organoleptic profile. In another embodiment, the protein powder prepared using the above said process contains high protein purity and high protein yield.

### Example 1: Effect of Antifoam Addition: Extraction was Carried Out in 2 Sets

In Set 1 (without antifoam agent)—300 g of Mung bean flour was mixed with 3 litres of RO water. pH of the slurry was adjusted to pH 9 with NaOH. The slurry was mixed at 25-30° C. for 1 hour. The mixture was centrifuged at 3000 g for 10 minutes and the supernatant was collected. The pH of the supernatant was adjusted between 4.5 to precipitate the protein. The protein slurry was held at set pH for 1 hour. The protein slurry was then centrifuged to obtain the protein curd. The protein curd was redispersed in water and the pH was neutralized to 7, with 5M HCl. The slurry was homogenized at 8000 RPM using IKA high shear mixer. The protein slurry was dried using a spray dryer.

In Set 2 (with antifoam agent)—300 g of Mung bean flour was mixed with 3 litres of RO water. pH of the slurry was adjusted to pH 9 with NaH. Anti foam Xiameter AFE-1520 was added at the solubilization stage and IEP stage (at 4 ppm of the liquid slurry at each stage). The slurry was mixed at 25-30° C. for 1 hour. The mixture was centrifuged at 3000 g for 10 minutes. The supernatant was collected. The pH of the supernatant was adjusted between 4.5 pH to 5 precipitate the protein. The protein slurry was held at set pH for 1 hour. The protein slurry was then centrifuged to obtain the protein curd. The protein curd was redispersed in water. pH was neutralized to pH7, with 5M HCL. The slurry was homogenized at 8000 RPM using IKA high shear mixer. The protein slurry was dried using a spray dryer.

### Results:

| | Set 1 | Set 2 |
|---|---|---|
| | Without | With |
| Mung bean protein sample | Antifoam agent | Antifoam agent |
| Protein Recovery % | 76.34 | 86.22 |
| Purity % (DB) of spray-dried powder | 80.8 | 86.74 |

| Mung bean | Protein | | Protein | | % | % | Emulsion | | |
|---|---|---|---|---|---|---|---|---|---|
| protein | % (wet | Moisture | % | % | foaming | foaming | capacity | | ESI |
| sample | basis) | % | (DB) | solubility | capacity | stability | (g/g) | EAI | (%) |
| Set 1 | 73.60 | 8.91 | 80.8 | 85.27 | 139 | 89.86 | 53.92 | 12.9 | 76.79 |
| Without | | | | | | | | | |
| antifoaming | | | | | | | | | |
| agent | | | | | | | | | |
| Set 2 | 82.12 | 5.33 | 86.74 | 84.85 | 131.18 | 100 | 55.14 | 13.52 | 92.56 |
| With | | | | | | | | | |
| Antifoaming | | | | | | | | | |
| agent | | | | | | | | | |

Observations: The addition of antifoaming agent led to a significant improvement in recovery and purity. Further, the protein obtained also had enhanced foaming stability, emulsion capacity, EAI and ESI features with respect to protein obtained without antifoaming agent.

### Example 2: Pilot Study for Addition of Antifoam (Single Stage Vs Multistage)

Mung bean protein extraction was carried out in 3 sets. In Set 1 (Antifoam in Solubilization step, 8 ppm of liquid slurry), Set 2 (Antifoam in IEP stage, 8 ppm of liquid slurry) and Set 3 (Antifoam addition in both Solubilization step and IEP step, 4 ppm of liquid slurry at each step)

100 kg of Mung bean flour was mixed with 1000 litres of RO water. pH of the slurry was adjusted to pH 9 with NaOH. The slurry was mixed at 25-30° C. for 1 hour. The starch was separated from the slurry using a decanter. The supernatant was collected. The pH of the supernatant was adjusted between 4.5 pH to precipitate the protein. The protein slurry was held at set pH for 1 hour. The protein slurry was then separated using a disc bowl centrifuge to obtain the protein curd. The protein curd was redispersed in water. The slurry was placed in a tank and homogenized using an inline homogenizer. pH was neutralized to pH7, with 5M HCl. The protein slurry was dried using a spray dryer.

### Results

| | Antifoam in | Antifoam | Antifoam |
|---|---|---|---|
| | Solubilization | in IEP | addition in |
| Mung bean protein sample | step only | step only | both steps |
| Protein Yield % w.r.t Raw | 22.2 | 20 | 25.6 |
| material | | | |
| Purity % (DB) of spray-dried | 75.02 | 74.36 | 83.92 |
| powder | | | |

| Mung bean | Protein | | Protein | | % | % | Emulsion | | |
|---|---|---|---|---|---|---|---|---|---|
| protein sample | % (wet | Moisture | % | % | foaming | foaming | capacity | | ES [symbol] |
| characteristics | basis) | % | (DB) | solubility | capacity | stability | (g/g) | EAI | (% [symbol] |
| Antifoam in | 70.63 | 5.85 | 75.02 | 77.42 | 129 | 98.45 | 49.88 | 14.20 | 20 |
| Solubilization | | | | | | | | | |
| step only | | | | | | | | | |
| Antifoam in | 70.46 | 5.24 | 74.36 | 81.96 | 132 | 97.03 | 50.08 | 14.12 | 26.6 [symbol] |
| IEP step only | | | | | | | | | |
| Antifoam | 79.04 | 5.81 | 83.92 | 82.81 | 139.22 | 98.59 | 55.21 | 14.27 | 88.1 [symbol] |
| addition in | | | | | | | | | |
| both steps | | | | | | | | | |

[symbol]

indicates data missing or illegible when filed

Observations: Addition of antifoaming agent in both solubilization and IEP step, led to a significant improvement in Recovery and Purity of mung bean protein. The protein obtained also had better foaming capacity, Emulsion capacity and ESI %.

This step of antifoam addition is observed to have a significant impact on recovery and purity in both lab scale and pilot trials. It is also seen to positively improve foaming and emulsion characteristics of the protein.

### Example 3: Effect of Freezing Post-Extraction Before Spray Drying Vs Immediate Spray Drying

300 g of Mung bean flour was mixed with 3 litres of RO water. pH of the slurry was adjusted to pH 9 with NaOH. Anti-foam Xiameter AFE-1520 was added at Solubilization stage and IEP stage (at 4 ppm of liquid slurry at each stage). The slurry was mixed at 25-30° C. for 1 hour. The mixture was centrifuged at 3000 g for 10 minutes. The supernatant was collected. The pH of the supernatant was adjusted between 4.5 pH (IEP) to precipitate the protein. The protein slurry was held at the set pH for 1 hour. The protein slurry was then centrifuged to obtain the protein curd.

In set 1 (with freezing), the protein curd was frozen at −20° C. and kept for 72 hours. After this time, the protein curd was thawed fully, was redispersed in water. The slurry was homogenized at 8000 RPM using IKA high shear mixer. pH was neutralized to pH7, with 5M HCL. The protein slurry was dried using a spray dryer.

In set 2 (without freezing), after centrifugation of IEP slurry, the protein curd was redispersed in water. The slurry was homogenized at 8000 RPM using IKA high shear mixer. pH was neutralized to pH7, with 5M HCL. The protein slurry was dried using a spray dryer.

| | With | Without |
|---|---|---|
| Mung bean protein sample | Freezing | Freezing |
| Recovery % | 87.9 | 87.5 |
| Purity % (DB) of spray-dried powder | 89.25 | 88.23 |

| | Protein | | Protein | | % | % | Emulsion | | |
|---|---|---|---|---|---|---|---|---|---|
| | % (wet | Moisture | % | % | foaming | foaming | capacity | | ESI |
| | basis) | % | (DB) | solubility | capacity | stability | (g/g) | EAI | (%) |
| With | 82.56 | 7.5 | 89.25 | 89.04 | 148.84 | 99.03 | 56.92 | 13.81 | 100.00 |
| Freezing | | | | | | | | | |
| Without | 81.24 | 7.92 | 88.23 | 86.01 | 144.37 | 97.34 | 56.11 | 13.32 | 92.59 |
| Freezing | | | | | | | | | |

Observations: An increase in solubility, better Foaming capacity, % Foaming stability, EAI and ESI was observed with freezing.

### Example 4: Pilot Study for Freezing Vs Immediate Spray Drying

100 kg of Mung bean flour was mixed with 1000 litres of RO water. pH of the slurry was adjusted to pH 9 with NaOH. Anti foam Xiameter AFE-1520 was added at Solubilization stage and IEP stage (at 4 ppm of the liquid slurry at each stage). The slurry was mixed at 25-30° C. for 1 hour. The starch was separated from the slurry using a decanter. The supernatant was collected. The pH of the supernatant was adjusted between 4.5 pH to precipitate the protein. The protein slurry was held at set pH for 1 hour. The protein slurry was then separated using a disc bowl centrifuge to obtain the protein curd. The protein curd was redispersed in water. The slurry was placed in a tank and homogenized using an inline homogenizer. pH was neutralized to pH7, with 5M HCL. The protein slurry was dried using a spray dryer.

| | Protein | | | | | | | | |
|---|---|---|---|---|---|---|---|---|---|
| | % | | Protein | | % | % | Emulsion | | |
| | (Wet | Moisture | % | % | foaming | foaming | capacity | | ESI |
| | basis) | % | (DB) | solubility | capacity | stability | (g/g) | EAI | (%) |
| With | 78.12 | 5.7 | 82.98 | 85.93 | 144.14 | 99.08 | 58.88 | 14.44 | 100 |
| Freezing | | | | | | | | | |
| Without | 79.04 | 5.81 | 83.92 | 82.81 | 139.22 | 98.59 | 55.21 | 14.27 | 88.14 |
| Freezing | | | | | | | | | |

Observations: In the pilot trials, a significant increase in solubility and better foaming capacity, foaming stability, emulsion capacity and ESI were observed with freezing.

The freezing step along with the addition of antifoam is seen to have a significant positive impact on the functional parameters for foaming and emulsion.

### Example 5: SDS-Page and Densitometric Study of Mung Bean Protein

Protein from mung bean protein isolates were resolved by SDS PAGE, under reducing conditions, in the presence of a molecular weight marker in the last lane. The storage protein profile pattern was quantified through densitometry. Mung bean proteins comprise largely (~90%) globulins, represented by 8s, 11s, and 7s globulins. 11S was composed of two bands of 40000 and 24000, 8S was composed of 60000, 48000, 32000, and 26000 bands, and basic 7S was composed of 28000 and 16000 bands.

### Batch Code

Batch B had O.D. of 20 and Batch A had O.D. of 24

The samples were diluted to 1:10 and was mixed with 6× reducing dye and loaded on SDS gel.

The results obtained are summarised in the below table:

% of total proteins (By densitometry)

| Type of proteins | BATCH A | BATCH B |
|---|---|---|
| Total Globulins | 83.82 | 87.42 |
| 8S | 71.31 | 74.72 |
| 7S | 3.83 | 3.93 |
| 11S | 8.68 | 8.77 |

The mung bean protein powder of the present invention had globulins of above 70% of total proteins and was observed to contain 8S, 7S, and 11S globulins.

### Example 6

The mung bean protein powder of the present invention was tested for Surface hydrophobicity (ANS binding method).

| | Surface |
|---|---|
| Sample | Hydrophobicity |
| Mung bean protein without antifoam and freezing | 1598 |
| Mung bean protein powder of the present invention | 870 |

Example 7: 1) Egg white powder 2) whole egg powder and 3) Mung bean protein powder of the present invention (isolate) were used in this comparative example to study the Hardness, Gumminess, Chewiness and rheology.

| | Protein % | | Protein % |
|---|---|---|---|
| Sample | (powder basis) | Moisture % | (dry basis) |
| Mung bean protein powder of | 73.95 | 7.73 | 80.14 |
| the present invention (isolate) | | | |
| Egg white powder (EWP) | 84.49 | 6.96 | 90.81 |
| Whole egg powder (WEP) | 48.09 | 3.66 | 49.92 |

The above mentioned 4 samples were initially prepared as suspensions (15 and 20% respectively). These suspensions were heated in 30 ml syringes for 1 hour in water bath of 95° C. and cooled overnight in a fridge. Next, they were cut into cylinders of 15 mm each. Each suspension was heated in duplicate and 3 cylinders per gel were measured.

The standard tests conducted yielded the following results:
Compared to the 15% protein gels, the 20% protein gels have a higher Hardness, Gumminess and Chewiness
Hardness, gumminess and chewiness is in the following order: [Eggwhite]>[Mungbean]>[Wholeegg]
With respect to rheology, the mung bean gel characteristics is closer to whole egg and egg white. The gelation onset temperature was observed to be similar for Mung bean protein and whole egg, while it was lower egg white.

Although several embodiments have been described in detail for purposes of illustration, various modifications may be made without departing from the scope and spirit of the present disclosure. Accordingly, the disclosure is not to be limited by the examples presented herein but is envisioned as encompassing the scope described in the appended claims and the full range of equivalents of the appended claims.

1. A process for extracting mung bean protein powder comprising the steps of:
i. reducing the size of the mung bean to obtain a flour of particle size less than 1000 μm;
ii. mixing said flour with water in a ratio of 1:5 to 1:10 to obtain a first slurry;
iii. solubilizing protein under stirring conditions over a time period of 30 mins to 1 hour by adjusting the pH of said first slurry in a range selected from 7.5 to 14 to obtain a solubilized protein;
iv. separating said solubilized protein from starch by using at least one of centrifugation, membrane filtration, hydro cyclone and combinations thereof to obtain a high purity protein in a supernatant;
v. subjecting said supernatant through a separation step to obtain a high purity protein slurry, wherein said separation step is at least one of centrifugation, micro ultra filtration or nano filtration;
vi. subjecting the high purity protein slurry to physico-thermal conditioning followed by adjusting the pH of said high purity protein slurry to attain pH 7 to obtain a conditioned mung bean protein in aqueous medium; and
vii. dispersing said conditioned mung bean protein in aqueous medium to obtain a dispersed mung bean protein followed by spray drying at pre-determined temperature for pre-determined time to obtain said mung bean protein powder;
wherein an antifoaming agent in predetermined quantity is added in at least one of the above-mentioned steps to obtain said mung bean protein powder.

2. The process as claimed in claim 1, wherein said flour is dry-fractionated using air classifier to obtain a fine protein rich fraction and a coarse starch rich fraction; wherein said coarse starch rich fraction further undergoes multiple steps of milling and air classification to further obtain fine protein rich fraction.

3. The process as claimed in claim 1, wherein said high purity protein in the supernatant is subjected to isoelectric precipitation followed by adjusting the pH to attain a range of 4 to 5.5 using an acid.

4. The process as claimed in claim 1, wherein said antifoaming agent is added to the first slurry after adjusting the pH of the first slurry, wherein, said antifoaming agent selected in the range from 0.1 to 10 ppm of the active component of the antifoam with respect to the total weight of the mung bean slurry.

5. The process as claimed in claim 1, wherein said antifoaming agent is added to the step of separating said solubilized protein, wherein, said antifoaming agent selected in the range from 0.1 to 10 ppm with respect to the total volume of the mung bean slurry.

6. The process as claimed in claim 1, wherein said antifoaming agent is added to the step of dispersing said conditioned mung bean protein in aqueous medium, wherein, said antifoaming agent selected in the range from 0.1 to 10 ppm of the active component of the antifoam with respect to the total volume of the protein slurry.

7. The process as claimed in claim 1, wherein said antifoaming agent is added to said protein slurry followed by stirring to obtain the conditioned mung bean protein.

8. The process as claimed in claim 1, wherein said antifoaming agent is selected from the group of cetostearyl alcohol, stearates, polydimethylsiloxane, silicone and polyethylene glycol-based processing aids.

9. The process as claimed in claim 1, wherein said mung bean has a moisture content selected in the range of 10 to 70%.

10. The process as claimed in claim 1, wherein said step of separation of solids is carried out using at least one of centrifugation, decanter, membrane filtration, and hydrocyclone.

11. The process as claimed in claim 1, wherein pH of said first slurry is adjusted in the range of 7.5 to 14 using a food grade alkali.

12. The process as claimed in claim 1, wherein pH of said mung bean protein slurry is adjusted in the range of 6 to 8 using a food grade alkali before drying.

13. The process as claimed in claim 1, wherein said physico-thermal conditioning is carried out at a temperature in the range of −22° C. to −16° C.

14. A mung bean protein powder obtained by the process as claimed in claim 1, wherein said mung bean protein powder comprises mung bean protein isolate and mung bean protein concentrate; wherein said mung bean protein powder has solubility of at least 65%.

15. The mung bean protein powder as claimed in claim 14, wherein said mung bean protein powder has:
foaming capacity and foaming stability, of at least 120% and at least 90% respectively at pH 7; and
emulsion capacity of at least 50%.

16. The mung bean protein powder as claimed in claim 14, wherein said mung bean protein powder comprises at least 70% by weight of globulin protein, wherein the globulin protein comprises 8S, 7S and 11S globulins.

17. The mung bean protein as claimed in claim 14, wherein said mung bean protein powder has an emulsion activity index and emulsion stability index of at least 10 and at least 90% respectively at pH 7.

18. The mung bean protein as claimed in claim 14, wherein, said mung bean protein has a surface hydrophobicity value less than 1200.
